(19) United States
(12) Patent Application Publication
(10) Pub. No.: US 2023/0236716 A1
(43) Pub. Date: Jul. 27, 2023

(54) Systems and Processes of Organization Management

(71) Applicant: Juan Ospina, Concord, NH (US)

(72) Inventor: Juan Ospina, Concord, NH (US)

(21) Appl. No.: 17/584,758

(22) Filed: Jan. 26, 2022

(51) Int. Cl. G06F 3/04847; G06Q 10/06

(52) U.S. Cl. CPC G06F 3/04847; G06Q 10/063118

(57) ABSTRACT

A computerized system for organization management is disclosed herein. The entire architecture and hierarchy of the system is structured and searchable based on only two elements: workspaces and activities. Only having two elements allows for the scalability of the system in addition to the self-management of the system by individual users. The system provides a unique process for managing the day-to-day activities of an organization as well as providing a source of knowledge for the organization. The four types of activity tools assures that the inner workings of an organization are continuously improved. The mirroring hierarchical structures of the system and an organization assure that an organization is aligned with cascaded goals and is supported with results. In other words, the system is structured in such a way to allow for easy implementation into any organization, regardless of the complexity of the organization's hierarchy, daily processes, or strategic goals.

### BACKGROUND

### Technical Field

The present disclosure relates generally to systems and processes of organization management. More particularly, the present disclosure relates to a computerized system for organization management, wherein the entire architecture and hierarchy of the system is structured and searchable based on the two individual centered elements: team workspaces and activities for the individuals.

### Description of Related Art

Skills are required to understand known systems and processes of organization management. The reason for this is that the known systems are tedious, time consuming, and the administration of such systems often requires skilled administrators. The prior art systems are complicated because there are different ways to administer the systems, and there are almost invariably multiple different locations and different ways to enter data properly. Implementing these prior art management systems is difficult, requires a tremendous amount of resources, and, even when such systems are implemented, the systems are isolated from daily organizational activities. Currently, there is no system or process that exists that is structured and aligned around the existing hierarchy of the organization; rather, the prior art systems come with their own modules and structures that implementing organizations are required to adapt to.

Therefore, what is needed is a system or process of organization management that has the following characteristics and benefits over the prior art.

### SUMMARY

The subject matter of this application may involve, in some cases, interrelated products, alternative solutions to a particular problem, and/or a plurality of different uses of a single system or article.

In one aspect, an organization management system comprising a system server, a processor, and a computer memory is disclosed. In this aspect, the computer memory is configured to store program instructions executable by the processor, and the processor is operable to conduct the following steps: (1) presenting on a user interface a plurality of workspaces, at least one of the plurality of workspaces being operable by a process; (2) presenting on the user interface a first activity, wherein the first activity controls the process; (3) receiving an input to assign the first activity to a user or a class of users; (4) receiving an input to define at least one of an objective or a project for the first activity; (5) receiving an input to set a deadline for completion of the first activity; and (6) saving the plurality of workspaces and the first activity in at least one of the computer memory or a database.

In another aspect, a workspace versioning system comprising a system server, a processor, and a computer memory is disclosed. In this aspect, the computer memory is also configured to store program instruction executable by the processor, and the processor is operable to conduct the following steps: (1) presenting on a user interface a plurality of workspaces, at least one of the plurality of workspaces being operable by a process; (2) presenting on the user interface a plurality of activities, wherein the plurality of activities controls the process and each one of the plurality of activities comprises at least one of an objective, a project, or an analysis; (3) receiving an indication that at least one of the objective, the project, or the analysis in at least one of the plurality of activities is complete; (4) archiving at least one completed activity from the plurality of activities in at least one of the computer memory or a database, the database being accessible over a network.

It should be expressly understood that the various physical elements of the present disclosure summarized and further disclosed herein may be of varying sizes, shapes, or otherwise dimensions and made from a variety of different materials or methods of manufacture without straying from the scope of the present disclosure.

### BRIEF DESCRIPTION OF THE DRAWINGS

FIG. 1 provides a perspective view of an embodiment of a system hierarchy aligned with the hierarchy of an organization according to the present disclosure.

FIG. 2 provides a perspective view of an embodiment of the setup of a workspace on a user interface display according to the present disclosure.

FIG. 3 provides a perspective view of an embodiment of the processes within a workspace according to the present disclosure.

FIG. 4 provides a perspective view of an embodiment of activities on a user interface display according to the present disclosure.

FIG. 5 provides a perspective view of an embodiment of the process of workspace versioning according to the present disclosure.

FIG. 6 provides a perspective view of an embodiment of a list of activities on a user interface display according to the present disclosure.

### DETAILED DESCRIPTION

The detailed description set forth below in connection with the appended drawings is intended as a description of presently preferred embodiments of the invention and does not represent the only forms in which the present disclosure may be constructed and/or utilized. The description sets forth the functions and the sequence of steps for constructing and operating the invention in connection with the illustrated embodiments.

Generally, the present disclosure concerns a computerized system for organization management, wherein the entire architecture and hierarchy of the system is structured and searchable based on the two elements of workspaces and activities. This structure for a computerized organization management system provides a unique process for managing the day-to-day projects and overall strategy for an organization as well as providing a source of knowledge for the organization, as opposed to the system merely being a container for information. The system is structured in such a way to allow for easy implementation into any organization, regardless of the complexity of the organization's hierarchy.

One embodiment of the present disclosure may include a non-transitory computer readable medium or memory, wherein the medium or memory contains instructions allowing and instructing a processor to carry out the steps required during the operation of the organization management system, as described herein. This non-transitory computer readable medium may be stored within a computer or other similar computerized device capable of housing a processor, and the system may be accessible through an electronic communication system, such as a network connection.

The organization management system contemplated herein may be carried out on a computerized and networked platform which allows users to log in via their own computers to a system with memory storing the data relating to the system, user interface information, and having local or networked access to a server or database containing information regarding workspaces, activities, or other processes, as described in further detail herein. The system includes a user interface, which may be accessible through a browser or application on a user's computer or computerized device.

In some embodiments, the user interface allows a user to set up a workspace, enter a workspace, and set up activities within the workspace. In some embodiments, as will be discussed further herein, there may be only four types (Pan, Do, Check, Act) of primary activities within the system, all of which may be configurable by users through a “Change Request” selection or input. In some embodiments, the “Plan Request” activities are the single method to add, edit, or remove the key elements of the system, which may include, but are not limited to, “Team”, “Roles”, “Documents”, “Training”, activity templates, process setup, business cycles, and more.

In some embodiments, the system utilizes an internal search engine or search criteria for all data within the system. In one embodiment, the system may be able to predefine a custom view unique to the user if the searching criteria for the data are saved in association with the individual pieces of data. This solves the problem of having data segregated in dedicated locations based on the type of data or the type of module that the data is associated with.

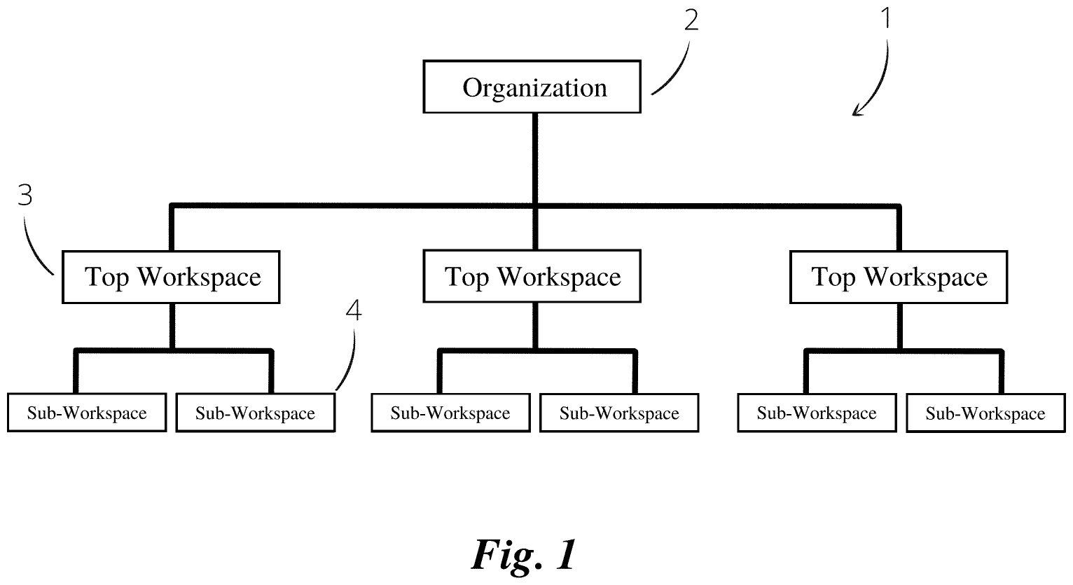

Turning now to FIG. 1, which shows an embodiment of a system 1 hierarchy aligned with the hierarchy of an organization 2. At a general level, FIG. 1 is an embodiment of the concept of the system 1 modeling the organization first and then providing tools and processes to system users second. All other organization management systems have modules designed to conform to standards and require users to adapt to those modules. Contrary to other systems, this system 1 adapts to the organization and its users while still conforming with any applicable standards. The system 1 accomplishes this by mirroring the structure of the organization 2. In other words, the embodiment shown in FIG. 1 essentially recreates the hierarchical structure of the organization 2 via a dynamic hierarchy of workspaces. In this embodiment, the hierarchy of workspaces comprises a plurality of top workspaces 3 and a plurality of sub-workspaces 4; however, other quantities and combinations are well within the scope of the present disclosure. For example, one embodiment may comprise only a plurality of top workspaces 3 and no sub-workspaces 4, and another embodiment may comprise only one top workspace 3 and at least one sub-workspace 4. In some embodiments, each top workspace 3 may be titled or represent a department or branch within the organization 2, and each sub-workspace 4 may represent a sub-department, a team, or a project within a department of the organization 2. For example and without limitation, in one embodiment a top workspace 3 may be titled or represent the product development department of a software company, and two sub-workspaces 4 may represent the mobile app development team and a mobile app development project, respectively.

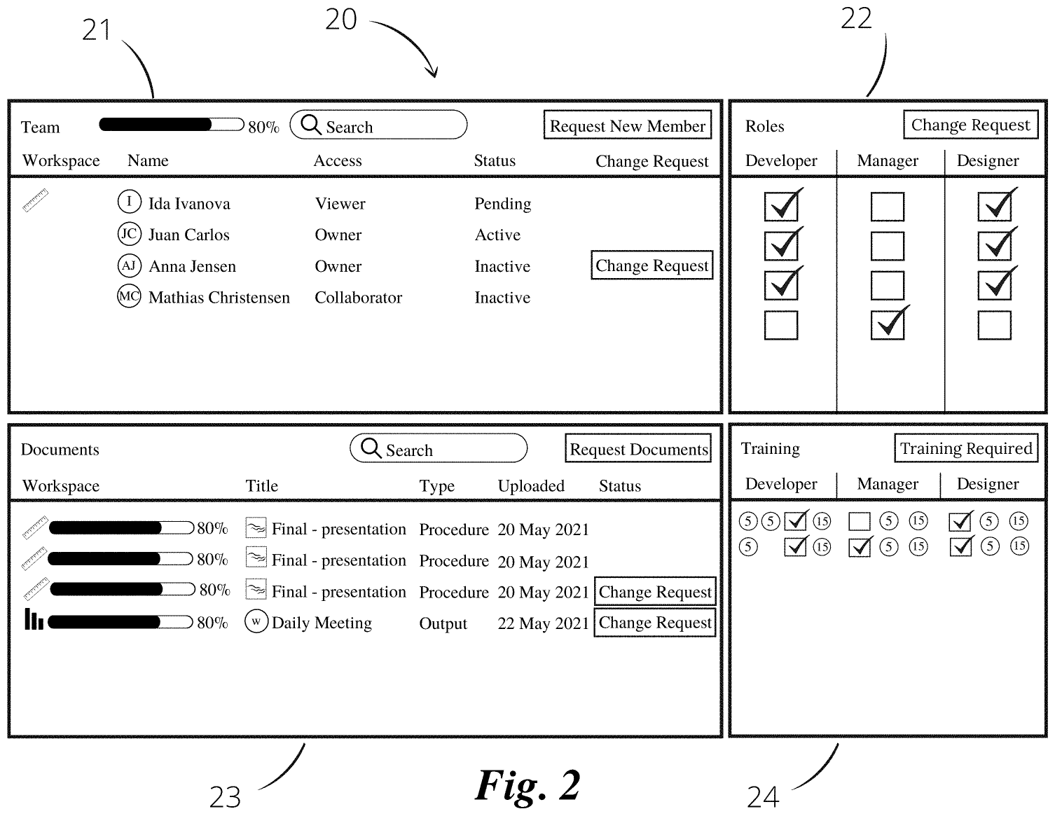

FIG. 2 shows an embodiment of the setup of a workspace on a single user interface display according to the present disclosure. At a general level, FIG. 2 is an embodiment of the concept of providing a single display to review all aspects of an organization's setup. The problem with other organization management systems is that these other systems have different displays to review the organization or workspace setup. This results in the system user needing to navigate into multiple screens and locations to define the aspects of an organization or a workspace. In this embodiment, the workspace 20 is setup with a “Team” 21, “Roles” 22, “Documents” 23, and “Training” 24 windows. Each of the aforementioned elements are tools provided for a workspace 20 and are not the processes or activities within the workspace 20, as will be discussed further herein. By providing a complete overview of the setup elements of a team, roles for team members, and documents or training required, the system allows for structured views with the priority on any of the elements in reference to the other three elements. This solves the problem of different displays to define system elements that is common in other organization management systems. This concept and specific embodiment also solves the problem of limited screen space that is unique to computerized systems. In short, the present embodiment solves the aforementioned problems by providing a single display for users to review all aspects of the setup of an organization or a workspace 20 without the need to navigate away from the setup display.

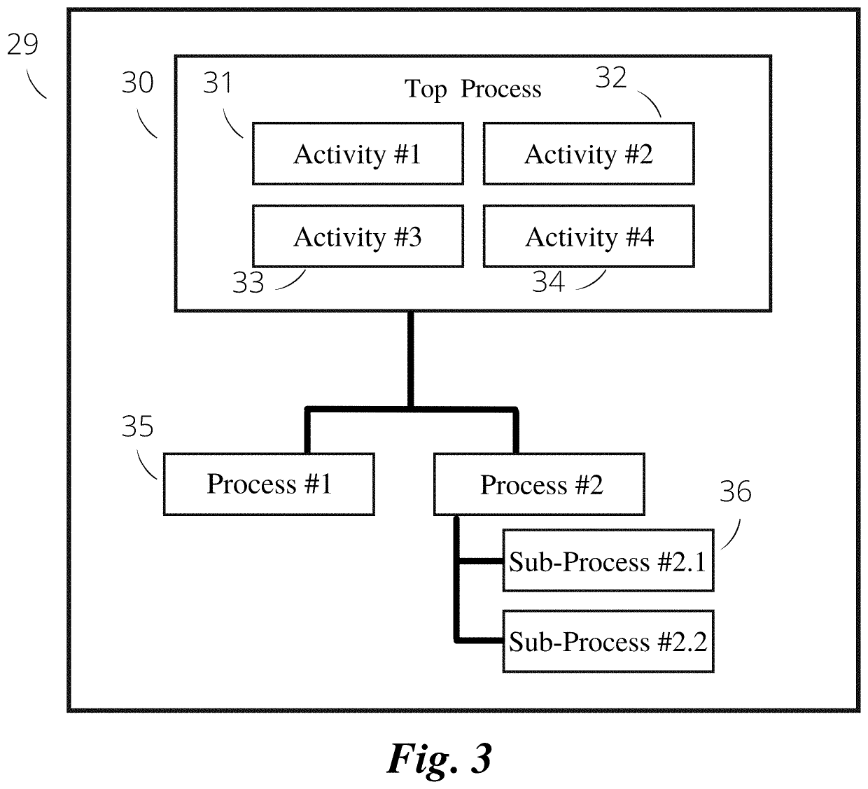

FIG. 3 shows an embodiment of the hierarchy of processes that build a workspace 29. In other words, in the embodiment shown in FIG. 3, the workspace 29 comprises a hierarchy of processes. For example, as shown in FIG. 3, the workspace 29 comprises a top process 30, a plurality of lower level processes 35, and a plurality of sub-processes 36. Depending on the embodiment, any number or combination of processes may build a workspace, and the processes within a workspace are modeled after the processes of the organization. As is illustrated by way of example in top process 30, each process is controlled by one or more activities. For example, in this embodiment, top process 30 is controlled by a first activity 31, a second activity 32, a third activity 33, and a fourth activity 34.

In most embodiments, all processes in the hierarchy of processes may be designed the same way. Similarly, in most embodiments, activities in the lower level and sub-processes may define day-to-day activities; whereas, activities for the top processes may define strategic initiatives for an organization. Moreover, in most embodiments, each team member may manage his or her own processes and activities in the same manner. As a result, the fact that in most embodiments all data in the system may be entered through a single tool, namely, the activity, allows the system to define a custom search view unique to a user. Since all user interactions with the system are done through activities, and all activities have a series of standard elements, the system provides powerful searches to any and all of the elements of the activities. Any given custom search view may be accessible to a team or a user by using the different standard and user-defined activity fields or data. In other words, all data in the system is easily searchable because all data is funneled and/or treated the same way by being entered into the system in association with an activity.

In a preferred embodiment of the present disclosure, there are four different types of activities that correspond to four types of standardized tasks: “Plan”; “Do”; “Check”; and “Act”. As mentioned briefly above, regarding the problems solved by the concepts behind the embodiment in FIG. 1, many companies struggle with the implementation and the operation of ISO management systems because they normally are not integrated within the business, and therefore, they generate additional documentation. The present platform's activity types of “Plan”, “Do”, “Check”, and “Act” assure that companies can accomplish ISO management compliance without extraordinary work.

In the preferred embodiment, “Plan” activities establish objectives, and, accordingly, all changes in the organization are completed with “Plan” activities. “Do” activities carry out and implement objectives, and, accordingly, “Do” activities correspond to routine projects within an organization. “Check” activities monitor the data and results of the implementation of objectives from either “Plan” or “Do” activities. For example, in some embodiments, “Check” activities may result in the production of performance charts for recurring tasks with a verification output. In some embodiments, “Check” activities may be connected from a lower level workspace to a higher level workspace. This method within the system may connect and cascade the goals of the organization from the top down and the bottom up. In some embodiments, the hierarchy of the system is defined by the teams within each workspace and the cascaded goals of the organization, which are discovered by “Check” activities. In other words, when reviewing the results of “Check” activities, the outputs from all lower level and higher level workspaces may be drawn together. This may allow system users to see problems across different projects and potentially systemic problems within the organization that may be corrected for all projects through the final type of activity: the “Act” activity. “Act” activities improve the processes within a workspace by identifying issues from the records generated by “Do” or “Check” activities. Accordingly, “Act” activities may trigger changes in the processes within a workspace, wherein the system may automatically define the changes required from “Act” activities as objectives in “Plan” activities.

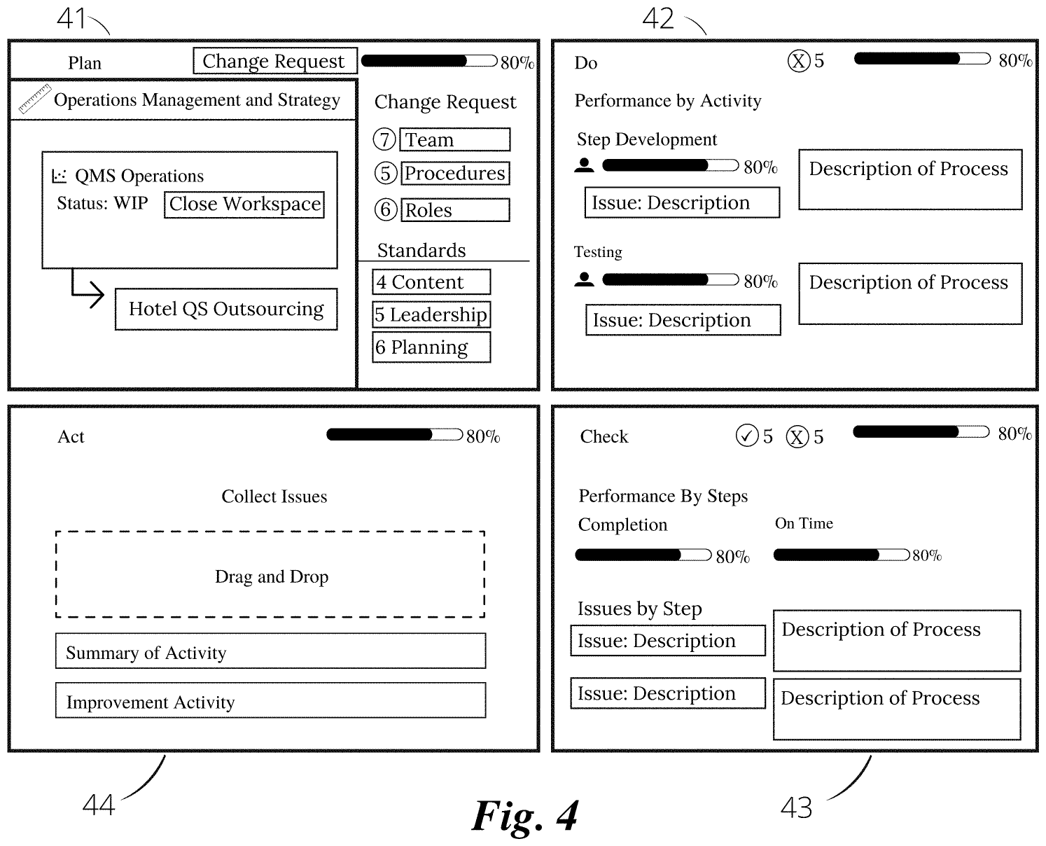

FIG. 4 shows an embodiment of activities on a single user interface display according to the present disclosure. At a general level, FIG. 4 is an embodiment of the concept of presenting a single display to monitor all aspects of the system in a single view. The problem with other organization management systems is that other systems have different displays to review the performance of all aspects of the system. In this preferred embodiment, each process has a complete overview of the four basic steps in the process, which are presented on a single display. In this embodiment, the four basic steps in each process are the “Plan” activities 41, the “Do” activities 42, the “Check” activities 43, and the “Act” activities 44. By providing each of the aforementioned process steps or activities on a single display, the preferred embodiment shown in FIG. 4 solves the problem with other known management systems as well as the problem of limited screen space that plagues computerized systems generally. This display provides users with a complete overview of the team and organization's performance in any given process within the system.

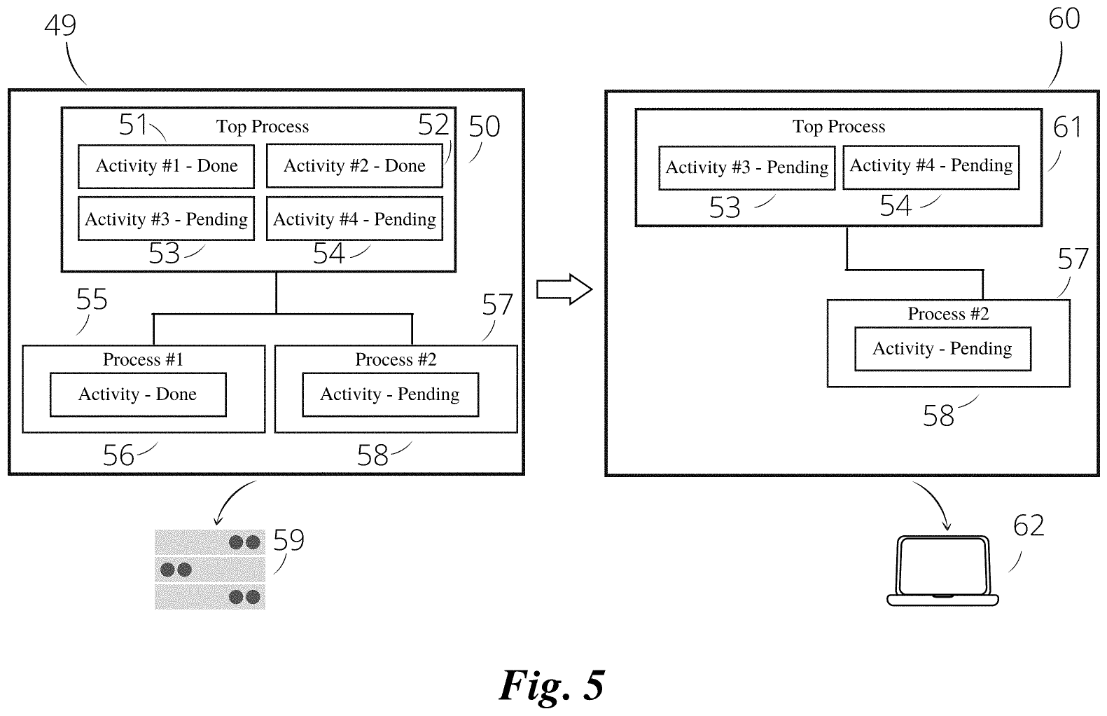

Turning now to FIG. 5, which shows an embodiment of the process of workspace versioning according to the present disclosure. The embodiment shown in FIG. 5 provides yet another example of how the present disclosure solves a computer-related problem. Other organizational management systems keep all data and information on the same level within a computerized system; however, the process of workspace versioning archives old data on a different level within, for example, the system memory or a database 59 than newer or current data. In most embodiments, two distinct types of information or data are carried over to a new workspace version: (1) the workspace setup elements, including, but not limited to, “Process Description”, “Teams”, “Roles”, “Documents”, “Activity Templates”, and “Training”; and (2) open activities. In such embodiments, all previous changes in the workspace setup elements and closed activities may remain locked in a previous workspace version. As will be described further below, this process provides a self-cleaning mechanism within the system that enables users to readily differentiate between more relevant, current data and old, less relevant information.

In a preferred embodiment, and still referring to FIG. 5, the system differentiates between old and current data based on business cycles. In such an embodiment, when a business cycle within a workspace comes to an end, the system archives activities that are completed or done by storing said activities within the system memory or a database 59. The system then keeps pending or open activities readily available on the user interface display 62. In such an embodiment, the old archived activity data, and the current activity data may be referred to as a workspace version, and the process of archiving old data and keeping current data readily available may be referred to as workspace versioning.

For example, in the embodiment shown in FIG. 5, a first workspace version 49 comprises a top process 50, wherein the top process 50 comprises a first lower-level process 55 and a second lower-level process 57. The top process 50 comprises a first completed activity 51, a second completed activity 52, a first open activity 53, and a second open activity 54. The first lower-level process 55 comprises a lower-level completed activity 56, and the second lower-level process 57 comprises a lower-level open activity 58. In this embodiment, the first completed activity 51, the second completed activity 52, and the lower-level completed activity 56 within the first lower-level process 55 are archived within a database 59, and a second workspace version 60 is created. The second workspace version 60 comprises an updated top process 61, which comprises the first open activity 53 and the second open activity 54. The second workspace version 60 also comprises the second lower-level process 57, which itself comprises the lower-level open activity 58. The second workspace version 60 is readily available on the user interface display 62; however, the first workspace version 49, and the archived processes and activities within it are still accessible via the database 59, and may also be displayed on the user interface display 62 in a separate window than the second workspace version 60.

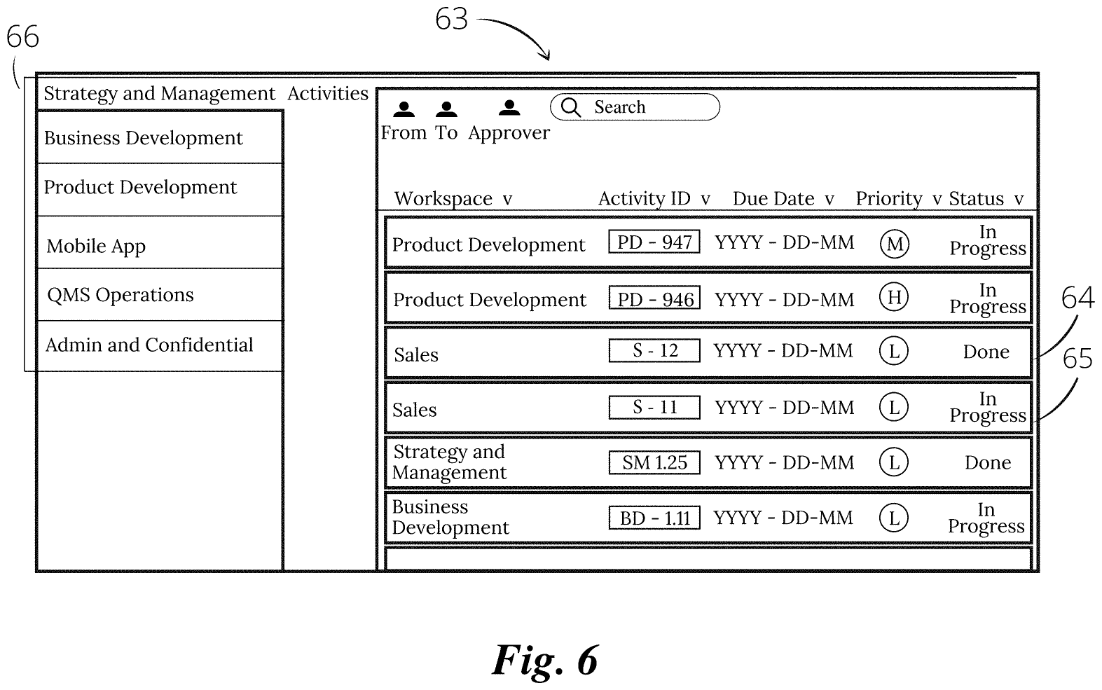

FIG. 6 provides an example of an embodiment of a list of activities 63 that may be displayed on a user interface display according to the present disclosure. In this embodiment, the list of activities 63 comprises both completed activities 64 and open activities 65. The activities shown are also from a plurality of different, yet current workspace versions 66 that are readily available on a user interface display. This demonstrates that the self-cleaning process of workspace versioning described in FIG. 5 may not necessarily render completed activities inaccessible to users. FIG. 6 also demonstrates that activities across all workspaces may be readily accessible to users.

While several variations of the present disclosure have been illustrated by way of example in preferred or particular embodiments, it is apparent that further embodiments could be developed within the spirit and scope of the present disclosure, or the inventive concept thereof. It is also to be expressly understood that elements described in one embodiment may be incorporated with any other embodiment in combination with any other elements disclosed herein in the various embodiments. It is also to be expressly understood that any modifications and adaptations to the present disclosure are within the spirit and scope of the present disclosure, and are inclusive, but not limited to the following appended claims as set forth.

1. An organization management system comprising:
a system server;
a processor; and
a computer memory, wherein the computer memory is configured to store program instructions executable by the processor, wherein the processor is operable to conduct the steps of:
presenting on a user interface a plurality of workspaces, at least one of the plurality of workspaces being operable by a process, and wherein a hierarchy for the plurality of workspaces is aligned with an organization hierarchy;
presenting on the user interface a first activity, wherein the first activity controls the process, and wherein the processor is further operable to conduct the step of presenting on the user interface a second activity, a third activity, and a fourth activity simultaneously with the first activity;
receiving an input to assign the first activity to a user or a class of users;
receiving an input to define at least one of an objective or a project for the first activity;
receiving an input to set a deadline for completion of the first activity;
saving the plurality of workspaces and the first activity in at least one of the computer memory or a database; and
wherein the only method of entering data or changing the organization management system is through at least one of the first activity, the second activity, the third activity, and the fourth activity.

2. (canceled)

3. The organization management system of claim 1 wherein the processor is further operable to conduct the step of presenting on the user interface a workspace setup display.

4. The organization management system of claim 3 wherein the workspace setup display comprises a team window, a roles window, a documents window, and a training window.

5. (canceled)

6. The organization management system of claim 1 wherein the second activity, the third activity, and the fourth activity also control the process with the first activity.

7. The organization management system of claim 1 wherein the processor is further operable to conduct the step of saving the second activity, the third activity, and the fourth activity in at least one of the computer memory or the database.

8. The organization management system of claim 1 wherein the first activity comprises a first plan activity, the second activity comprises a do activity, the third activity comprises a check activity, and the fourth activity comprises an act activity.

9. The organization management system of claim 8 wherein the first plan activity comprises an objective.

10. The organization management system of claim 8 wherein the do activity comprises at least one of an objective or a project within an organization.

11. The organization management system of claim 8 wherein the check activity comprises the step of monitoring at least one of data or results from at least one of an objective or a project from at least one of the plan activity or the do activity.

12. The organization management system of claim 8 wherein the act activity comprises the step of defining an objective for a second plan activity.

13. The organization management system of claim 1 wherein the database is accessible over a network.

14. The organization management system of claim 1 wherein the processor is further operable to conduct the step of presenting on the user interface a list of a plurality of activities, wherein each one of the plurality of activities is associated with at least one of the plurality of workspaces.

15. The organization management system of claim 1 further comprising an internal search engine.

16. The organization management system of claim 15 wherein the processor is further operable to control the internal search engine to conduct the step of locating at least one of the plurality of workspaces in at least one of the computer memory or the database.

17. The organization management system of claim 16 wherein the processor is further operable to carry out the step of displaying on the user interface the at least one of the plurality of workspaces in order to create a custom view.

18. A workspace versioning system comprising:
a system server;
a processor; and
a computer memory, wherein the computer memory is configured to store program instructions executable by the processor, wherein the processor is operable to conduct the steps of:
presenting on a user interface a plurality of workspaces, at least one of the plurality of workspaces being operable by a process;
presenting on the user interface a plurality of activities, wherein the plurality of activities controls the process and each one of the plurality of activities comprises at least one of an objective, a project, or an analysis;
receiving an indication that at least one of the objective, the project, or the analysis in at least one of the plurality of activities is complete;
archiving at least one completed activity from the plurality of activities in at least one of the computer memory or a database, the database being accessible over a network;
wherein the at least one completed activity is archived in a different level within the computer memory or the database than the plurality of activities, such that the at least one completed activity is locked in a previous workspace version.

19. The workspace versioning system of claim 18 wherein the processor is further operable to conduct the step of presenting on the user interface a list of the plurality of activities.

20. The workspace versioning system of claim 19 wherein the list of the plurality of activities includes the at least one completed activity.
